(19) United States
(12) Patent Application Publication
(10) Pub. No.: US 2023/0056085 A1
(43) Pub. Date: Feb. 23, 2023

(54) MULTI-LAYERED MULTI-SPECTRAL TARGET FOR RIFLES

(71) Applicant: Nathan Fahndrich, Weidman, MI (US)

(72) Inventor: Nathan Fahndrich, Weidman, MI (US)

(21) Appl. No.: 17/405,170

(22) Filed: Aug. 18, 2021

(51) Int. Cl. F41J 1/01; B32B 7/023; B32B 3/26

(52) U.S. Cl. CPC F41J 1/01; B32B 7/023; B32B 3/266; B32B 2307/412; B32B 2307/7265; B32B 2307/732; B32B 2307/416; B32B 2307/206; B32B 2307/4026; B32B 2250/05

(57) ABSTRACT

A multi-layered, multi-spectral target for rifles. The multi-layered target comprises a first layer printed rifle target having at least one target position on a first surface and a light reflective film surmounted on a second surface of the first layer printed rifle target. There is a cutout silhouette layer surmounted on the light-reflective film wherein the light reflective film shows through the cutout silhouette.

### BACKGROUND OF THE INVENTION

Various thermal active targets and related devices are known in the art. For example, U.S. Pat. No. 4,058,734 that issued on Nov. 15, 1977, to Vroombout deals with a passive target array for measuring the resolution of infrared reconnaissance sets having a heat retaining background pad. This device operates on infrared emissions.

U.S. Pat. No. 7,377,517 that issued May 27,2008 deals with a target device for firing practice. At least one thermal target surface is heated by an electrically current passing through the target. This device requires electrical heating to operate.

U.S. Pat. No. 7,820,969 that issued Oct. 26, 2010, to Guinn et al deals with a target with a thermal imaging system comprising a layered composite. This too requires electrical heating to operate.

U.S. Pat. No. 7,939,802 that issued May 10, 2011, to Guinn et al deals with the same subject matter as U.S. Pat. No. 7,820,969.

U.S. Pat. No. 8,424,876 that issued Apr. 23, 2013, to Hutchinson et al deals with a multi-layered device that requires a heating element and a fastening structure connectable to the target body for mounting the heating element to the target body.

U.S. Pat. No. 8,985,585 that issued Mar. 24, 2015, to Hodge deals with a thermal signal generating device including at least two parallel buss bars operable for carrying a current and a heating element.

U.S. Pat. No. 9,341,444 that issued May 17, 2016, to Levine, et al deals with a thermal electric image device that requires conductive foils or other metal materials to form a pattern in addition to conductive inks. The device may be construct using conductive inks as well. The device requires some type of electrical current to pass through the pattern.

U.S. Pat. No. 10,060,711 that issued Aug. 28, 2018, to Spooner et al deals with a thermally emissive apparatus having an electro-thermal heating element.

Another device dealing with infrared operational targets is U.S. Pat. No. 3,986,384 that issued on Oct. 19, 1976, to Giorgi. This device is painted with high emissivity paint, and it is done in two levels of emissivity.

U.S. Pat. No. 5,065,032 discloses thermal integrated target that produces and emits an infrared image for simulating heat emitting equipment or personnel. It relies on the passage of electrical current through it.

U.S. Pat. No. 4,260,160 deals with an active thermal target for night vision and it comprises a thin supple fabric supported on a rigid frame. An infrared radiator heats the heat-absorbing sheet which radiates as a black body forming an image.

Multi-spectral targets that can be used either in the nighttime or in the daytime can be found in U.S. Pat. No. 5,599,023 that deals with a partially translucent mural and the means for supplying warm air into a bag disposed on one side of the target.

None of the prior art references deal with a simple multi-layered multi-spectral target that does not require conductive layers nor poser from a power source such as batteries, the electrical grid, hot air balloons, electrified blankets, hot air or the like.

### THE INVENTION

Thus, what is disclosed herein is a multi-layered, multi-spectral target for rifles. The multi-layered target comprises a first layer printed rifle target having at least one target position on a first surface and a light reflective film surmounted on a second surface of the first layer printed rifle target.

There is a cutout silhouette layer surmounted on the light-reflective film wherein the light reflective film shows through the cutout silhouette.

In addition, it is contemplated within the scope of this invention to provide a multi-layered, multi-spectral target for rifles as set forth just Supra, wherein the multi-layered target is laminated on both surfaces with a transparent plastic.

The device is lightweight, low cost, environmentally disposable and is high quality with regard to its use. The device will tolerate very low emissivity in use wherein “very low” means in the range of 0.22 to 0.29.

### BRIEF DESCRIPTION OF THE DRAWINGS

FIG. 1 illustrates a multi-layered device of this invention.

FIG. 2A illustrates one pattern for the cutout silhouette portion of this invention.

FIG. 2B illustrates another potential pattern for the cutout silhouette portion of this invention.

FIG. 2C illustrates yet another potential pattern for the cutout silhouette portion of this invention.

FIG. 3 illustrates a multiple layered device of this invention with laminating layers on each outside surface separated for clarity.

### DETAILED DESCRIPTION OF THE DRAWINGS

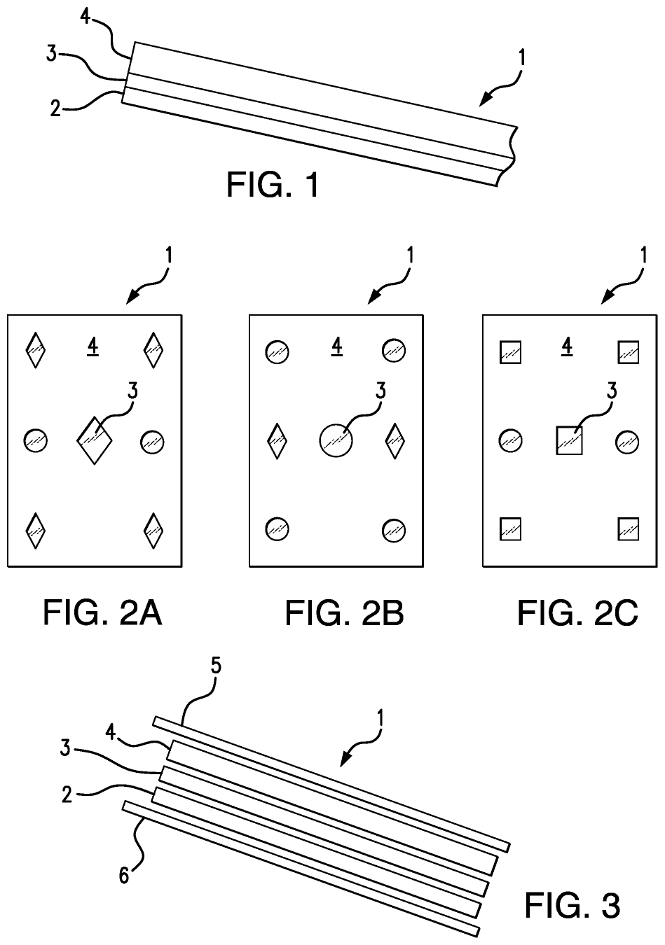

FIG. 1 is an edge view of the multi-layered device 1 of this invention. Shown is the first layer printed rifle target 2 and the light reflective film 3 surmounted on a second surface of the first layer printed rifle target 2. There is a cutout silhouette layer 4 surmounted on the light reflective film 3. As shown in FIGS. 2A, 2B, and 2C, the cutout silhouette layer 4 can have just about any pattern that the user desires. The pattern provides for multiple target zeros. In one use, the first layer printed rifle target 2 can be used as a standard rifle target.

In another use, the other surface, showing the light reflective film 3 and the cutout silhouette layer 4 can be used with a thermal rifle scope and can even be used after dark. With a target of this type, the emissivity of the light reflective film 3 is much larger than the emissivity of the cutout silhouette layer 4 and the difference can be very small.

It is contemplated within the scope of the invention to laminate the multi-layered device 1 with transparent plastic coverings 5 and 6 on both sides of the device 1.

FIG. 3 shows a device 1 with the laminate covers 5 and 6.

The main object of the present invention is to provide a new and improved target for use with rifles. Another object would be to provide such a target that is very simple to construct and very inexpensive and does not require a coating material and the relevant disadvantages in using the same.

In addition, it is an object of this invention to provide for a light weight, easily deployable target without of use of special tools or transport equipment.

What is claimed is:

1. A multi-layered, multi-spectral target for rifles, said multi-layered target comprising:
A) a first layer printed rifle target having at least one target position on a first surface;
B) a light reflective film surmounted on a second surface of said first layer printed rifle target;
C) a cutout silhouette layer surmounted on said light reflective film wherein said light reflective film shows through said cutout silhouette.

2. A multi-layered, multi-spectral target for rifles as claimed in claim 1 wherein said multi-layered target is laminated on both surfaces with a transparent plastic.

3. A multi-layered, multi-spectral target for rifles as claimed in claim 2 wherein said plastic lamination is waterproof.

4. A multi-layered, multi-spectral target for rifles as claimed in claim 1 wherein said multi-spectral target has an overall size ranging from 6×4 inches to 14×10 inches.

5. A multi-layered, multi-spectral target for rifles as claimed in claim 1 wherein the multi-layered target has a thickness ranging from 0.5 mm to 3.0 mm.

6. A multi-layered, multi-spectral target for rifles as claimed in claim 1 wherein said plastic lamination is electrically non-conductive.

7. A multi-layered, multi-spectral target for rifles as claimed in claim 1 wherein said cutout silhouette has variable designs.

8. A multi-layered, multi-spectral target for rifles as claimed in claim 1 wherein said cutout silhouette is colored.

9. A multi-layered, multi-spectral target for rifles as claimed in claim 8 wherein said cutout silhouette is black.

10. A multi-layered, multi-spectral target for rifles as claimed in claim 4 wherein said cutout silhouette is dark green.
